(19) United States
(12) Patent Application Publication
(10) Pub. No.: US 2024/0243376 A1
(43) Pub. Date: Jul. 18, 2024

(54) TEMPERATURE SENSOR SHARING SYSTEM, SECONDARY BATTERY PROTECTION INTEGRATED CIRCUIT, BATTERY DEVICE, AND TEMPERATURE DETECTION METHOD

(71) Applicants: Takeshi YAMAGUCHI, Tokyo (JP); Junji TAKESHITA, Tokyo (JP)

(72) Inventors: Takeshi YAMAGUCHI, Tokyo (JP); Junji TAKESHITA, Tokyo (JP)

(73) Assignee: MITSUMI ELECTRIC CO., LTD., Tokyo (JP)

(21) Appl. No.: 18/407,916

(22) Filed: Jan. 9, 2024

(30) Foreign Application Priority Data
Jan. 13, 2023 (JP) 2023-003638

(51) Int. Cl. H01M 10/48; H01M 10/42; H01M 10/637; H02J 7/00

(52) U.S. Cl. CPC H01M 10/486; H01M 10/637; H02J 7/00309; H02J 7/007182; H01M 2010/4271; H01M 2200/105

(57) ABSTRACT

A first device: determines whether or not a terminal voltage at a terminal, where a temperature sensor, in which a physical quantity such as a resistance value or a voltage value varies due to changes in temperature, is connected, is in a first voltage range; controls the terminal voltage to vary in accordance with changes of the physical quantity, within the first voltage range, when the terminal voltage is determined to be in the first voltage range, and stops controlling the terminal voltage to vary within the first voltage range when the terminal voltage is determined not to be in the first voltage range; and detects temperature based on the terminal voltage. A second device: controls the terminal voltage to vary in accordance with changes of the physical quantity, within a second voltage range, which is different from the first voltage range; and detects temperature based on the terminal voltage.

### CROSS-REFERENCE TO RELATED APPLICATION

This application is based on and claims priority to Japanese Patent Application No. 2023-003638, filed on Jan. 13, 2023, the entire contents of which are incorporated herein by reference.

### BACKGROUND OF THE INVENTION

### 1. Field of the Invention

The present disclosure relates to a temperature sensor sharing system, a secondary battery protection integrated circuit, a battery device, and a temperature detection method.

### 2. Description of the Related Art

There is a technique to provide a negative temperature coefficient (NTC) thermistor inside a battery pack and output signals to an external device connected to the battery pack, such as a charger or the like, thereby ensuring temperature protection by means of the external device (see, for example, FIG. 2 of Patent Document 1). The resistance value of the NTC thermistor decreases at high temperatures. So, when the NTC thermistor's resistance value drops to some extent, the external device determines that the temperature exceeds a predetermined level and carries out temperature protection by, for example, shutting off the current and stopping charging.

On the other hand, in the event the external device has no such temperature protection function, a technique to allow the battery pack to carry out temperature protection by itself by providing an NTC thermistor inside the battery pack may be used (see, for example, FIG. 1 of Patent Document 1). When the resistance value of the NTC thermistor drops to some extent, a protection IC provided inside the battery pack carries out temperature protection by, for example, turning off a charging control FET and stopping charging.

### Related-Art Document

### Patent Document

[Patent Document 1] Unexamined Japanese Patent Application Publication No. 2009-100605

### SUMMARY OF THE INVENTION

### Problem to be Solved by the Invention

However, if a first device such as a battery pack and a second device such as a charger are provided and both devices have a temperature detection function, a temperature sensor such as an NTC thermistor needs to be provided in both the first device and the second device, which then makes it difficult to reduce the size and cost of the devices.

The present disclosure therefore aims to allow multiple devices to use a temperature sensor on a shared basis.

### Means for Solving the Problem

According to one embodiment of the present disclosure, a temperature sensor sharing system includes:
a temperature sensor, in which a physical quantity varies due to changes in temperature, the physical quantity being a resistance value or a voltage value;
a terminal, to which the temperature sensor is connected;
a first device; and
a second device, and, in this temperature sensor sharing system,
the first device includes:
   a determination circuit configured to determine whether or not a terminal voltage at the terminal is in a first voltage range;
   a first control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
   a first detection circuit configured to detect the terminal voltage and
the second device includes:
   a second control circuit configured to control the terminal voltage to vary in accordance with changes of the physical quantity, within a second voltage range, which is different from the first voltage range; and
   a second detection circuit configured to detect the terminal voltage.

According to one embodiment of the present disclosure, a secondary battery protection integrated circuit is configured to protect a secondary battery by controlling a transistor provided on a current path that is connected to the secondary battery, and this secondary battery protection integrated circuit includes:
a terminal that is connected with a temperature sensor, in which a physical quantity varies due to changes in temperature, the physical quantity being a resistance value or a voltage value;
a determination circuit configured to determine whether or not a terminal voltage at the terminal is in a first voltage range;
a control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
a detection circuit configured to detect the terminal voltage.

According to one embodiment of the present disclosure, a battery device includes:
a secondary battery;
a transistor provided on a current path that is connected to the secondary battery;
a temperature sensor, in which a physical quantity varies due to changes in temperature, the physical quantity being a resistance value or a voltage value;
a terminal, to which the temperature sensor is connected;
a determination circuit configured to determine whether or not a terminal voltage at the terminal is in a first voltage range;
a control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
a detection circuit configured to detect the terminal voltage.

According to one embodiment of the present disclosure, a temperature detection method involves a first device and a second device, and includes:
in the first device:
   determining whether or not a terminal voltage at a terminal, to which a temperature sensor, in which a physical quantity varies due to changes in temperature, is connected, is in a first voltage range, the physical quantity being a resistance value or a voltage value;
   controlling the terminal voltage to vary in accordance with changes of the physical quantity, within the first voltage range, when the terminal voltage is determined to be in the first voltage range, and stopping controlling the terminal voltage to vary within the first voltage range when the terminal voltage is determined not to be in the first voltage range; and
   detecting temperature based on the terminal voltage, and
in the second device:
   controlling the terminal voltage to vary in accordance with changes of the physical quantity within a second voltage range, which is different from the first voltage range; and
   detecting temperature based on the terminal voltage.

### Effect of the Invention

According to the present disclosure, multiple devices can use a temperature sensor on a shared basis.

### BRIEF DESCRIPTION OF THE DRAWINGS

FIG. 1 is a circuit block diagram that shows an example of a system including a secondary battery protection integrated circuit according to a first embodiment;

FIG. 2 is a timing chart that shows an example of terminal voltage behavior;

FIG. 3 is a diagram that shows an example circuit state when a PMIC in an electronic device monitors temperature;

FIG. 4 is a diagram that shows an example circuit state when a protection IC in a battery device monitors temperature;

FIG. 5 is a diagram that shows temperature as a parameter for a terminal voltage that varies in a first voltage range and a terminal voltage that varies in a second voltage range;

FIG. 6 is a diagram that shows example structures of a determination circuit and a detection circuit;

FIG. 7 is a diagram that shows examples of operating waveforms of a temperature detection circuit;

FIG. 8 is a diagram that shows examples of operating waveforms of a temperature detection circuit; and

FIG. 9 is a circuit block diagram that shows an example of a system including a secondary battery protection integrated circuit according to a second embodiment.

### MODE OF CARRYING OUT THE INVENTION

Embodiments of the present disclosure will be described below with reference to the accompanying drawings.

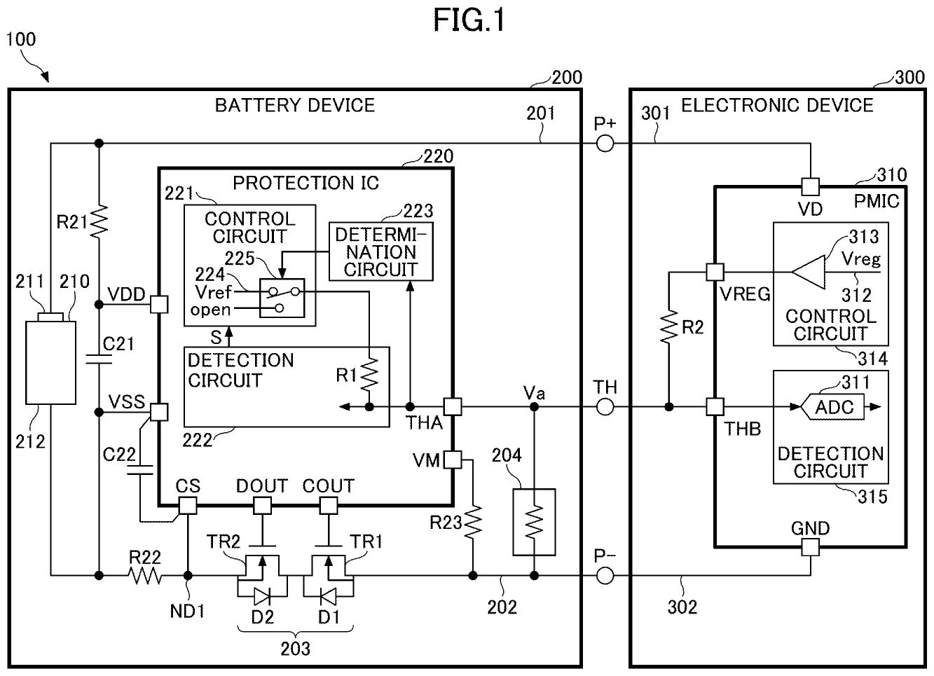

FIG. 1 is a circuit block diagram that shows an example of a system including a secondary battery protection integrated circuit according to a first embodiment. As shown in FIG. 1, a system 100 includes a battery device 200 and an electronic device 300. For example, the electronic device 300 is a portable device such as a mobile phone, a smartphone, a tablet, or an earphone. Note that the electronic device 300 is not limited to a portable device as long as it is connected with the battery device 200.

The system 100 is an example of a temperature sensor sharing system. In this example, the battery device 200 and the electronic device 300 use a temperature detecting element 204 on a shared basis. The battery device 200 is an example of the first device. The electronic device 300 is an example of the second device. The temperature detecting element 204 is an example of the temperature sensor.

The battery device 200 is, for example, a battery pack that is detachably housed inside the electronic device 300, and can supply power to the electronic device 300 while connected to the electronic device 300. The battery device 200 and the electronic device 300 are connected with each other via multiple terminals, indicated by circles in FIG. 1 (namely, a positive power supply terminal (terminal P+), a negative power supply terminal (terminal P−), and a temperature detection terminal (terminal TH)). For example, when charging the secondary battery 210, the terminal P+ and the terminal P− are connected to a charger, a power-supply adapter, or the like, via a universal serial bus (USB) port (not shown) of the electronic device 300. The electronic device 300 itself may be a charger, a power supply adapter, or the like.

The battery device 200 includes a secondary battery 210, a switching circuit 203, a protection integrated circuit (IC) 220, resistance elements R21, R22, and R23, capacitors C21 and C22, and a temperature detecting element 204. The protection IC 220 is an example of a secondary battery protection integrated circuit for protecting the secondary battery 210.

The secondary battery 210 is a rechargeable lithium ion battery, a lithium polymer battery, or the like. The secondary battery 210 has a positive electrode 211 and a negative electrode 212. The secondary battery 210 supplies power to the electronic device 300 that is connected to the terminal P+ and the terminal P−.

The positive electrode 211 and the terminal P+ are connected via a power supply line 201, which is a positive current path. The power supply line 201 is a power supply path that connects between the positive electrode 211 and the terminal P+. The power supply line 201 functions as a charging path, through which a current to charge the secondary battery 210 flows, and as a discharging path, through which a current that is discharged from the secondary battery 210 flows.

The negative electrode 212 and the terminal P− are connected via a grounding wire 202, which is a negative current path. The grounding wire 202 is a power supply path that connects between the negative electrode 212 and the terminal P−. The grounding wire 202 functions as a charging path, through which a current to charge the secondary battery 210 flows, and as a discharging path, through which a current that is discharged from the secondary battery 210 flows.

The switching circuit 203 is provided on the grounding wire 202 between the negative electrode 212 and the terminal P−. The switching circuit 203 is, for example, a series circuit, which includes a charge control transistor TR1 and a discharge control transistor TR2 and in which these charge control transistor TR1 and discharge control transistor TR2 are connected in series. The charge control transistor TR1 is a semiconductor switching element that disconnects the charging path of the secondary battery 210. The discharge control transistor TR2 is a semiconductor switching element that disconnects the discharging path of the secondary battery 210.

In FIG. 1, the charge control transistor TR1 shuts off connection to the grounding wire 202 through which the charging current of the secondary battery 210 flows, and the discharge control transistor TR2 shuts off connection to the grounding wire 202 through which the discharging current of the secondary battery 210 flows. The charge control transistor TR1 and the discharge control transistor TR2 are switching elements that switch between connection and disconnection with the grounding wire 202, and are inserted in series with the grounding wire 202. The charge control transistor TR1 and the discharge control transistor TR2 are, for example, N-channel metal oxide semiconductor field effect transistors (MOSFETs).

The charge control transistor TR1 has a parasitic diode D1 between its drain and source. The forward direction of the parasitic diode D1 is opposite to the direction of the charging current of the secondary battery 210. The charge control transistor TR1 is a switching element that is inserted in series with the grounding wire 202 such that the forward direction of the parasitic diode D1 matches the direction in which the discharging current of the secondary battery 210 flows.

The discharge control transistor TR2 has a parasitic diode D2 between its drain and source. The forward direction of the discharge control transistor TR2 is opposite to the direction of the discharging current of the secondary battery 210. The discharge control transistor TR2 is a switching element that is inserted in series with the grounding wire 202 such that the forward direction of the parasitic diode D2 matches the direction in which the charging current of the secondary battery 210 flows.

The protection IC 220 is an example of the secondary battery protection integrated circuit. The protection IC 220 operates by using the secondary battery 210 as its power supply.

The protection IC 220 has a function to protect the secondary battery 210 from over-discharging and the like by controlling the switching circuit 203. For example, when the detection circuit 222 detects a problem related to charging (for example, overcharging, an overcurrent in the charging direction (a charging overcurrent), etc.), the protection IC 220 protects the secondary battery 210 from the charging-related problem by turning off the charge control transistor TR1. Also, when the detection circuit 222 detects a problem related to discharging (for example, over-discharging, an overcurrent in the discharging direction (a discharging overcurrent), etc.), the protection IC 220 protects the secondary battery 210 from the discharging-related problem by turning off the discharge control transistor TR2.

The protection IC 220 has a function to protect the secondary battery 210 from temperature-related problems by controlling the switching circuit 203. For example, when the detection circuit 222 detects a problem related to temperature (for example, an abnormally high temperature or an abnormally low temperature), the protection IC 220 can prevent the charging current from flowing to the secondary battery 210 while the temperature is abnormally high or abnormally low, by turning off the charge control transistor TR1. For example, when the detection circuit 222 detects a problem related to temperature (for example, an abnormally high temperature or an abnormally low temperature), the protection IC 220 can prevent the discharging current from flowing to the secondary battery 210 while the temperature is abnormally high or abnormally low, by turning off the discharge control transistor TR2.

The protection IC 220 includes, for example, a charge control terminal (terminal COUT), a discharge control terminal (terminal DOUT), a monitoring terminal (terminal VM), a power supply terminal (terminal VDD), a grounding terminal (terminal VSS), a current detection terminal (terminal CS), and a temperature detection terminal (terminal THA). These terminals are external connection terminals for connecting the inner circuitry of the protection IC 220 to the outside of the protection IC 220.

The terminal COUT is connected to the gate (control electrode) of the charge control transistor TR1, and outputs signals for turning the charge control transistor TR1 on and off. The terminal DOUT is connected to the gate (control electrode) of the discharge control transistor TR2, and outputs signals for turning the discharge control transistor TR2 on and off.

The terminal VM is used to monitor the potential at the terminal P−, and connected to the terminal P−. The terminal VM is used, for example, by the detection circuit 222 in the protection IC 220 to monitor whether the electronic device 300 or a charger is connected. The terminal VM is connected to the grounding wire 202 via a resistance element R23 between the switching circuit 203 and the terminal P−.

The terminal VDD is a power supply terminal of the protection IC 220, and connected to the positive electrode 211 of the secondary battery 210 and the power supply line 201 via the resistance element R21. The terminal VSS is a grounding terminal of the protection IC 220, and connected to the negative electrode 212 of the secondary battery 210. The capacitor C21 is connected between the terminal VDD and the terminal VSS. The terminal VSS is connected to the grounding wire 202 between the switching circuit 203 and the negative electrode 212. In this example, the terminal VSS is connected to the grounding wire 202 between the resistance element R22 and the negative electrode 212.

The terminal CS is connected to a connecting node ND1, which connects the resistance element R22 and the switching circuit 203 (the source of the discharge control transistor TR2). Also, the terminal CS is connected to the terminal VSS via the capacitor C22. The resistance element R22 is inserted in series with the grounding wire 202. One end of the resistance element R22 is connected to the terminal VSS, and the other end is connected to the terminal CS. The protection IC 220 can detect a charging overcurrent or a discharging overcurrent that flows to the secondary battery 210 by detecting the potential difference between the terminal VSS and the terminal CS. The resistance element R22 functions as a sensing resistor that detects the current flowing through the secondary battery 210.

The terminal THA is an example of a terminal for temperature detection, and provided between the resistance element R1 and the temperature detecting element 204. The resistance element R1 has a first resistance value (for example, 100 kΩ). The resistance element R1 and the temperature detecting element 204 are connected in series between a reference voltage source 224 and the grounding wire 202. One end of the resistance element R1 is connected to the terminal THA, and the other end of the resistance element R1, which is opposite the terminal THA, is connected to the reference voltage source 224. In the example of FIG. 1, a switch 225 is provided between the resistance element R1 and the reference voltage source 224, so that the other end of the resistance element R1, which is opposite the terminal THA, is connected to the reference voltage source 224 via the switch 225. However, the positions where the switch 225 and the resistance element R1 are provided may be swapped.

The reference voltage source 224 is a circuit that generates a constant reference voltage Vref. The reference voltage source 224 generates a constant reference voltage Vref (for example, 0.5 volts) by, for example, dividing a band gap reference voltage (approximately 1.25 volts). The reference voltage source 224 is an example of a first reference voltage source.

One end of the temperature detecting element 204 is connected to the terminal TH and the terminal THA and the other end is connected to the grounding wire 202 between the switching circuit 203 and the terminal P−. The temperature detecting element 204 is a temperature sensing element, in which a physical quantity, which is the resistance value or the voltage value, varies due to changes in temperature. The temperature detecting element 204 detects the ambient temperature of the secondary battery 210 in the battery device 200. The temperature detecting element 204 is, for example, an NTC thermistor. An NTC thermistor is a temperature sensing resistor, and its resistance value varies with negative temperature coefficient characteristics depending on its own temperature. The temperature detecting element 204 may be any sensor other than an NTC thermistor as long as it is a sensor in which a physical quantity, which is the resistance value or the voltage value, varies due to changes in temperature.

The protection IC 220 includes the reference voltage source 224, a detection circuit 222, a control circuit 221, and a determination circuit 223. The detection circuit 222 is an example of the first detection circuit. The control circuit 221 is an example of the first control circuit.

The detection circuit 222 detects overcharging of the secondary battery 210 by monitoring the power-supply voltage between the terminal VDD and the terminal VSS, and detects a discharging overcurrent from the secondary battery 210 by monitoring the potential difference between the terminal VSS and the terminal CS.

When the detection circuit 222 continues detecting overcharging or a charging overcurrent to the secondary battery 210 for a predetermined detection delay time, the control circuit 221 outputs a signal (for example, a low-level gate control signal) to switch the charge control transistor TR1 from on to off, from the terminal COUT. The control circuit 221 turns off the charge control transistor TR1, thereby preventing a current in the direction to charge the secondary battery 210 from flowing into the grounding wire 202. As a result of this, charging of the secondary battery 210 stops, so that the protection IC 220 can protect the secondary battery 210 from overcharging or a charging overcurrent.

The detection circuit 222 detects over-discharging of the secondary battery 210 by monitoring the power-supply voltage between the terminal VDD and the terminal VSS, and detects a discharging overcurrent from the secondary battery 210 by monitoring the potential difference between the terminal VSS and the terminal CS.

When the detection circuit 222 continues detecting over-discharging or a discharging overcurrent from the secondary battery 210 for a predetermined detection delay time, the control circuit 221 outputs a signal (for example, a low-level gate control signal) to switch the discharge control transistor TR2 from on to off, from the terminal DOUT. The control circuit 221 turns off the discharge control transistor TR2, thereby preventing a current in the direction to discharge the secondary battery 210 from flowing into the grounding wire 202. As a result of this, discharging of the secondary battery 210 stops, so that the protection IC 220 can protect the secondary battery 210 from over-discharging or a discharging overcurrent.

The determination circuit 223 determines whether or not the terminal voltage Va at the terminal THA is in a first voltage range (hereinafter also referred to as “first voltage range A1”).

When the determination circuit 223 determines that the terminal voltage Va is in the first voltage range A1, the control circuit 221 pulls up the terminal THA to the reference voltage source 224, via the resistance element R1, by turning on the switch 225. On the other hand, when the determination circuit 223 determines that the terminal voltage Va is not in the first voltage range A1, the control circuit 221 stops pulling up the terminal THA to the reference voltage source 224, via the resistance element R1, by turning off the switch 225.

The detection circuit 222 includes the resistance element R1. The detection circuit 222 detects the terminal voltage Va at the terminal THA by using the resistance element R1 that pulls up the terminal THA to the reference voltage source 224. If a terminal voltage Va exceeding the predetermined first voltage range continues being detected for a predetermined temperature detection delay time, the detection circuit 222 asserts a predetermined signal S. The assertion of the signal S indicates that the terminal voltage Va has moved out of the predetermined first voltage range (in other words, the temperature corresponding to the terminal voltage Va has moved out of the predetermined first temperature range).

When the predetermined signal S is asserted, the control circuit 221 shuts off connection to the grounding wire 202 by turning off one or both of the charge control transistor TR1 and the discharge control transistor TR2. As a result of this, the current that flows to the secondary battery 210 at an abnormally high or an abnormally low temperature is shut off. The protection IC 220 can therefore protect the battery device 200 and the secondary battery 210 from temperature-related problems.

The electronic device 300 includes a resistance element R2 and a power management IC (PMIC) 310. The PMIC 310 is an integrated circuit that includes a power supply terminal (terminal VD), a grounding terminal (terminal GND), a voltage output terminal (terminal VREG), and a temperature monitoring terminal (terminal THB). These terminals are external connection terminals for connecting the inner circuitry of the PMIC 310 to the outside of the PMIC 310. The terminal VREG or the terminal THB may be a general-purpose input/output terminal.

The terminal VD is connected to the terminal P+ via a power supply line 301. The terminal GND is connected to the terminal P− via a grounding wire 302. The PMIC 310 operates in accordance with a power-supply voltage that is applied between the terminal VD and the terminal GND via the power supply line 301 and the grounding wire 302.

The terminal THB is connected to the terminal TH. The terminal THB is connected to the terminal THA and the temperature detecting element 204 via the terminal TH.

One end of the resistance element R2 is connected to the terminal TH and the terminal THB and the other end of the resistance element R2 is connected to the terminal VREG. One end of the resistance element R2 is connected to the terminal THA and the temperature detecting element 204 via the terminal TH. The resistance element R2 has a second resistance value (for example, 10 kΩ), which is lower than the first resistance value.

The PMIC 310 includes a control circuit 314 and a detection circuit 315. The control circuit 314 is an example of a second control circuit. The detection circuit 315 is an example of a second detection circuit.

When monitoring the temperature of the battery device 200, the control circuit 314 sets the level of the terminal VREG to an active level (high level in this example). For example, the control circuit 314 turns on the buffer 313, thereby outputting a constant reference voltage Vreg, which is generated by a reference voltage source 312, to the terminal VREG, and setting the terminal VREG to the high level. On the other hand, when the control circuit 314 stops monitoring the temperature of the battery device 200, the control circuit 314 sets the terminal VREG to a high impedance. For example, the control circuit 314 stops outputting the reference voltage Vreg to the terminal VREG by turning off the buffer 313, and sets the terminal VREG to a high impedance.

The reference voltage source 312 is a circuit that generates a constant reference voltage Vreg. The reference voltage source 312 generates, for example, a constant reference voltage Vreg (for example, 3.3 volts) that has a higher voltage value than the reference voltage Vref. The reference voltage source 312 is an example of a second reference voltage source.

The detection circuit 315 detects the terminal voltage Va, which is input through the terminal TH and the terminal THB, by using the resistance element R2 that pulls up the terminal TH and the terminal THB to the reference voltage source 312. The control circuit 314 detects the temperature of the battery device 200 based on the terminal voltage Va, which is detected by the detection circuit 315 during the period in which the terminal VREG level is set to an active level (high level in this example). The detection circuit 315 includes, for example, an analog-to-digital converter (ADC) 311 that converts the analog terminal voltage Va, which is input from the terminal THB, into a digital value. The control circuit 314 detects the temperature of the battery device 200 based on the digital value of the terminal voltage Va, which is detected by the ADC 311 during the period in which the terminal VREG level is set to an active level (high level in this example).

For example, when the terminal voltage Va detected by the detection circuit 315 is in a predetermined second voltage range, the control circuit 314 allows the charger to charge the secondary battery 210 in the battery device 200. By this means, the PMIC 310 can allow the charger to charge the secondary battery 210 in the battery device 200 under an appropriate temperature environment. On the other hand, when the terminal voltage Va that is detected by the detection circuit 315 is outside the predetermined second voltage range, the control circuit 314 prevents the charger from charging the secondary battery 210 in the battery device 200. By this means, the PMIC 310 can prevent the charger from charging the secondary battery 210 in the battery device 200 under an inappropriate temperature environment.

Next, the operation in which the electronic device 300 (PMIC 310) and the battery device 200 (protection IC 220) detect temperature by using the temperature detecting element 204 on a shared basis will be described in more detail.

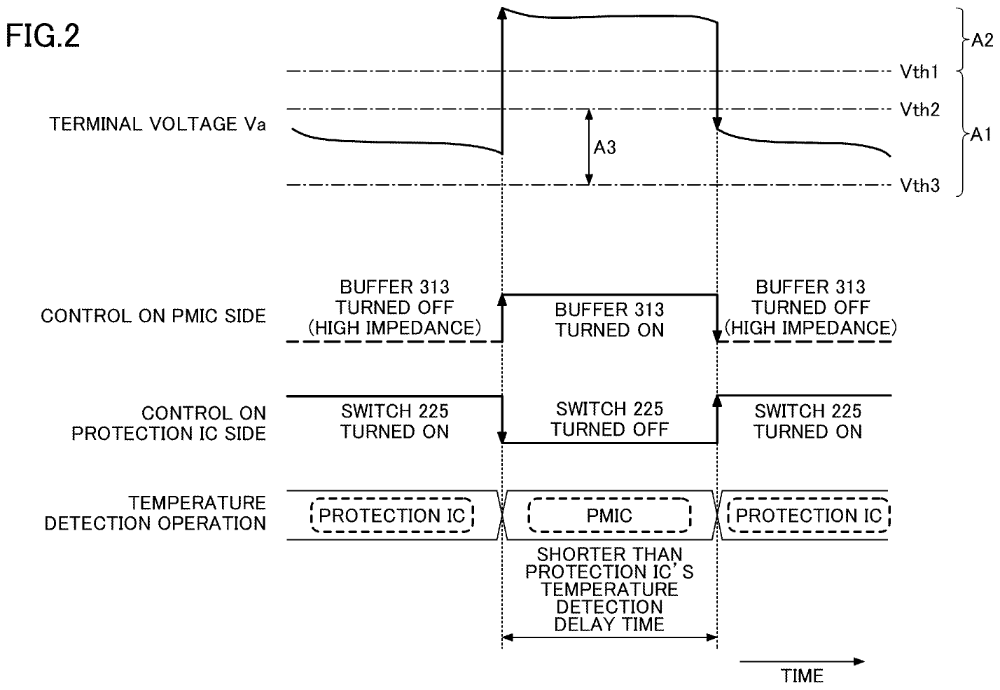

In the first embodiment shown in FIG. 1, when monitoring the temperature of the battery device 200, the control circuit 314 in the electronic device 300 activates the connection between the terminal THA and the reference voltage source 312 by means of the buffer 313. In this example, the control circuit 314 sets the level of the terminal VREG to an active level (high level in this example) by turning on the buffer 313. Turning on the buffer 313 enables (activates) the resistance element R2. In this way, by turning on the buffer 313, the control circuit 314 controls the terminal voltage Va to vary in accordance with changes of the resistance value of the temperature detecting element 204, within a second voltage range A2, which is different from the first voltage range A1 described above (see FIG. 2).

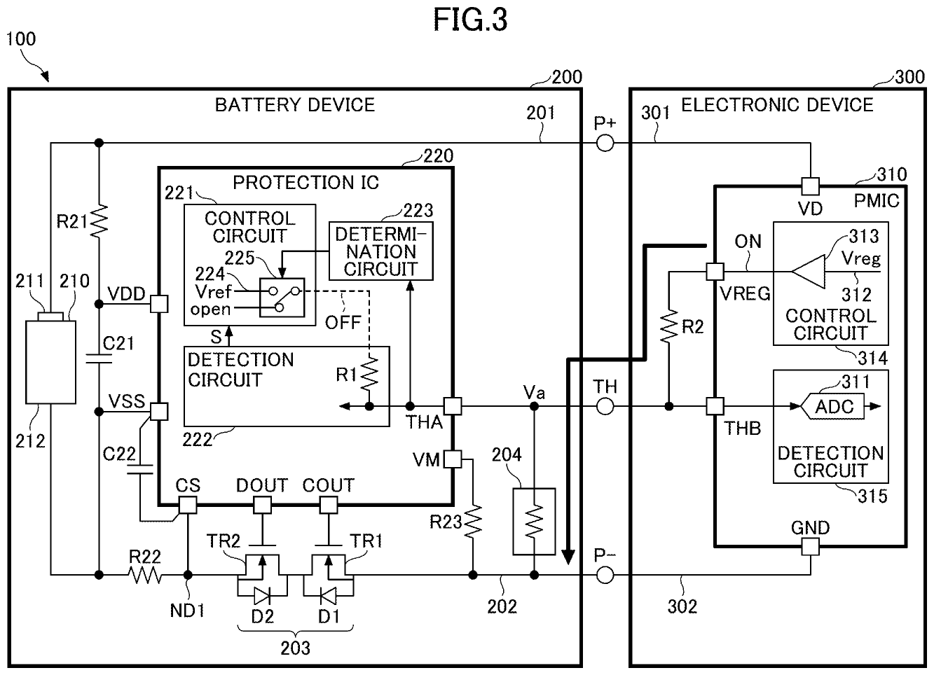

When the terminal voltage Va is controlled to vary in accordance with changes of the resistance value of the temperature detecting element 204, within the second voltage range A2, the terminal voltage Va shifts to the second voltage range A2, so that the determination circuit 223 in the battery device 200 determines that the terminal voltage Va is not in the first voltage range A1. When the determination circuit 223 determines that the terminal voltage Va is not in the first voltage range A1, the control circuit 221 in the battery device 200 turns off the switch 225. By turning off the switch 225, the control circuit 221 stops pulling up the terminal THA to the reference voltage source 224 via the resistance element R1 (see FIG. 3). By turning off the switch 225, the resistance element R1 is disabled (deactivated). Thus, the control circuit 221 deactivates the connection between the terminal THA and the reference voltage source 224 by means of the switch 225, thereby stopping controlling the terminal voltage Va to vary in accordance with changes of the resistance value of the temperature detecting element 204, within the first voltage range A1. Therefore, as shown in FIG. 3, the detection circuit 315 is unaffected by the resistance value of the resistance element R1 and still can detect the voltage obtained by dividing the reference voltage Vreg between the resistance element R2 and the temperature detecting element 204 as the terminal voltage Va.

Next, when the control circuit 314 in the electronic device 300 stops monitoring the temperature of the battery device 200, the control circuit 314 deactivates the connection between the terminal THA and the reference voltage source 312 through the buffer 313. In this example, the control circuit 314 sets the terminal VREG to a high impedance by turning off the buffer 313 (see FIG. 2). By setting the terminal VREG to a high impedance, the resistance element R2 is disabled, so that the terminal voltage Va shifts from the second voltage range A2 to the first voltage range A1 (see FIG. 2). In this way, by turning off the buffer 313, the control circuit 314 stops controlling the terminal voltage Va to vary, in accordance with changes of the resistance value of the temperature detecting element 204, within the second voltage range A2.

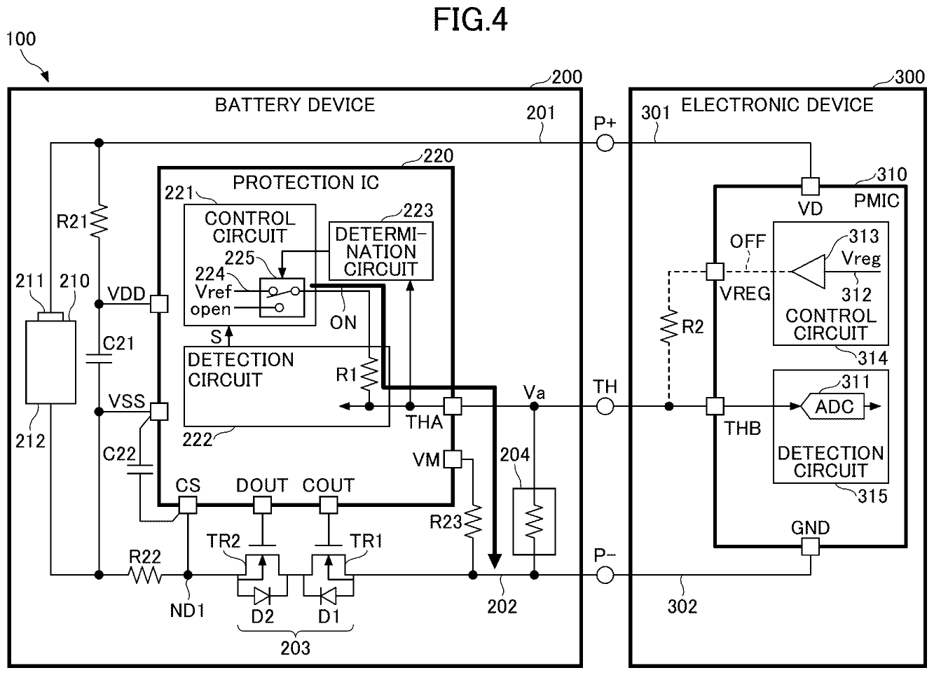

When the terminal voltage Va shifts to the first voltage range A1, the determination circuit 223 in the battery device 200 determines that the terminal voltage Va is in the first voltage range A1. When the determination circuit 223 determines that the terminal voltage Va is in the first voltage range A1, the control circuit 221 in the battery device 200 turns on the switch 225. By turning on the switch 225, the control circuit 221 pulls up the terminal THA to the reference voltage source 224 via the resistance element R1 (see FIG. 4). By turning on the switch 225, the resistance element R1 is enabled. Thus, the control circuit 221 controls the terminal voltage Va to vary in accordance with changes of the resistance value of the temperature detecting element 204, within the first voltage range A1, by activating the connection between the terminal THA and the reference voltage source 224 by means of the switch 225.

Therefore, as shown in FIG. 4, the detection circuit 222 is unaffected by the resistance value of the resistance element R2 and can still detect the voltage obtained by dividing the reference voltage Vref between the resistance element R1 and the temperature detecting element 204, as the terminal voltage Va.

In this way, according to the first embodiment shown in FIG. 1, the electronic device 300 (PMIC 310) and the battery device 200 (protection IC 220) can use the temperature detecting element 204, for temperature detection, on a shared basis.

According to the first embodiment, by using the resistance element R1, the control circuit 221 in the battery device 200 sets the electrical resistance between the terminal THA and the reference voltage source 224 to a first resistance value. The control circuit 221 sets the electrical resistance between the terminal THA and the reference voltage source 224 to the first resistance value, thereby controlling the terminal voltage Va to vary in accordance with changes of the resistance value of the temperature detecting element 204, within the first voltage range A1. On the other hand, the control circuit 314 in the electronic device 300 sets the electrical resistance between the terminal THA and the reference voltage source 312 to a second resistance value by using a resistance element R2. The control circuit 314 sets the electrical resistance between the terminal THA and the reference voltage source 312 to the second resistance value, thereby controlling the terminal voltage Va to vary in accordance with changes of the resistance value of the temperature detecting element 204, within the second voltage range A2.

As shown in FIG. 2, the control circuit 314 of the electronic device 300 stops controlling the terminal voltage Va to vary in accordance with changes of the resistance value of the temperature detecting element 204, within the second voltage range A2, in a period of time that is shorter than the temperature detection delay time described above. By this means, in the battery device 200, the detection circuit 222 does not continue detecting a terminal voltage Va exceeding the predetermined first voltage range for a predetermined temperature detection delay time, so that it is possible to prevent the detection circuit 222 from erroneously asserting a predetermined signal S. The temperature detection delay time is only an example of the predetermined first period of time, and is set in advance in the detection circuit 222 of the protection IC 220 in this example.

If the detection circuit 222 continues detecting a terminal voltage Va outside the first voltage range A1 or outside a predetermined range A3 included in the first voltage range A1 for a predetermined temperature detection delay time, the detection circuit 222 asserts a predetermined signal S. By this means, when the terminal voltage Va moves out of the predetermined first voltage range, the detection circuit 222 can immediately assert a predetermined signal S after a predetermined temperature detection delay time has elapsed.

As shown in FIG. 2, the range A3 is a voltage range between a threshold voltage Vth2 and a threshold voltage Vth3. The threshold voltage Vth2 and the threshold voltage Vth3 are included in the first voltage range A1. The threshold voltage Vth2 may be an upper limit voltage corresponding to the minimum threshold temperature (abnormally low temperature) when the protection IC 220 shuts off the current flowing through the secondary battery 210. The threshold voltage Vth3 may be a lower limit voltage corresponding to the maximum threshold temperature (abnormally high temperature) when the protection IC 220 shuts off the current flowing through the secondary battery 210. The range A3 may be a voltage range corresponding to a temperature range in which the protection IC 220 allows current to flow through the secondary battery 210.

When a terminal voltage Va outside the first voltage range A1 or a terminal voltage Va outside the predetermined range A3 included in the first voltage range A1 continues being detected for a predetermined temperature detection delay time (when a predetermined signal S is asserted), the control circuit 221 controls the switching circuit 203 (see FIG. 1). For example, the control circuit 221 shuts off connection to the grounding wire 202 by turning off one or both of the charge control transistor TR1 and the discharge control transistor TR2 in the switching circuit 203. By this means, the protection IC 220 can protect the battery device 200 and the secondary battery 210 from temperature-related problems.

When a predetermined signal S is asserted, the control circuit 221 may shut off connection to the grounding wire 202 by controlling the switching circuit 203, regardless of whether or not a charging-related problem or a discharging-related problem is detected with respect to the secondary battery 210. By this means, even if no charging-related problem or discharging-related problem is detected with respect to the secondary battery 210, insofar as a problem related to temperature is detected, the protection IC 220 can protect the battery device 200 and the secondary battery 210 from the temperature-related problem.

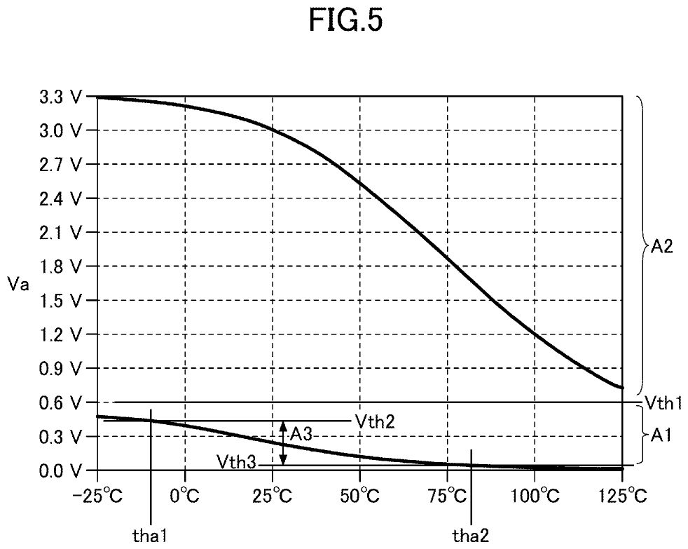

FIG. 5 is a diagram that shows temperature as a parameter for the terminal voltage Va that varies in the first voltage range A1 and the terminal voltage Va that varies in the second voltage range A2. The determination circuit 223 determines whether or not the terminal voltage Va is in the first voltage range A1 by comparing the terminal voltage Va with the threshold voltage Vth1, for example. In this case, if a terminal voltage Va that is lower than the threshold voltage Vth1 is detected, the determination circuit 223 determines that the terminal voltage Va is in the first voltage range A1. On the other hand, if a terminal voltage Va that is higher than the threshold voltage Vth1 is detected, the determination circuit 223 determines that the terminal voltage Va is not in the first voltage range A1 (the determination circuit 223 may determine that the terminal voltage Va is in the second voltage range A2). Note that threshold voltage Vth1 is an example of the first threshold voltage.

The detection circuit 222 determines whether or not the terminal voltage Va is outside the predetermined range A3 by comparing the terminal voltage Va with the threshold voltage Vth2 or the threshold voltage Vth3. In this case, if a terminal voltage Va that is lower than the threshold voltage Vth3 or higher than the threshold voltage Vth2 is detected, the determination circuit 223 determines that the terminal voltage Va is outside the range A3. A terminal voltage Va lower than the threshold voltage Vth3 represents a state in which a temperature that is higher than the maximum threshold temperature tha2 is detected by the temperature detecting element 204. A terminal voltage Va higher than the threshold voltage Vth2 represents a state in which a temperature that is lower than the minimum threshold temperature tha1 is detected by the temperature detecting element 204. On the other hand, if a terminal voltage Va that is higher than the threshold voltage Vth3 and lower than the threshold voltage Vth2 is detected, the determination circuit 223 determines that the terminal voltage Va is in the range A3. A terminal voltage Va that is higher than the threshold voltage Vth3 and lower than the threshold voltage Vth2 represents a state in which the temperature detecting element 204 detects a temperature that is higher than the minimum threshold temperature tha1 and lower than the maximum threshold temperature tha2. Note that the threshold voltage Vth2 or the threshold voltage Vth3 is an example of the second threshold voltage.

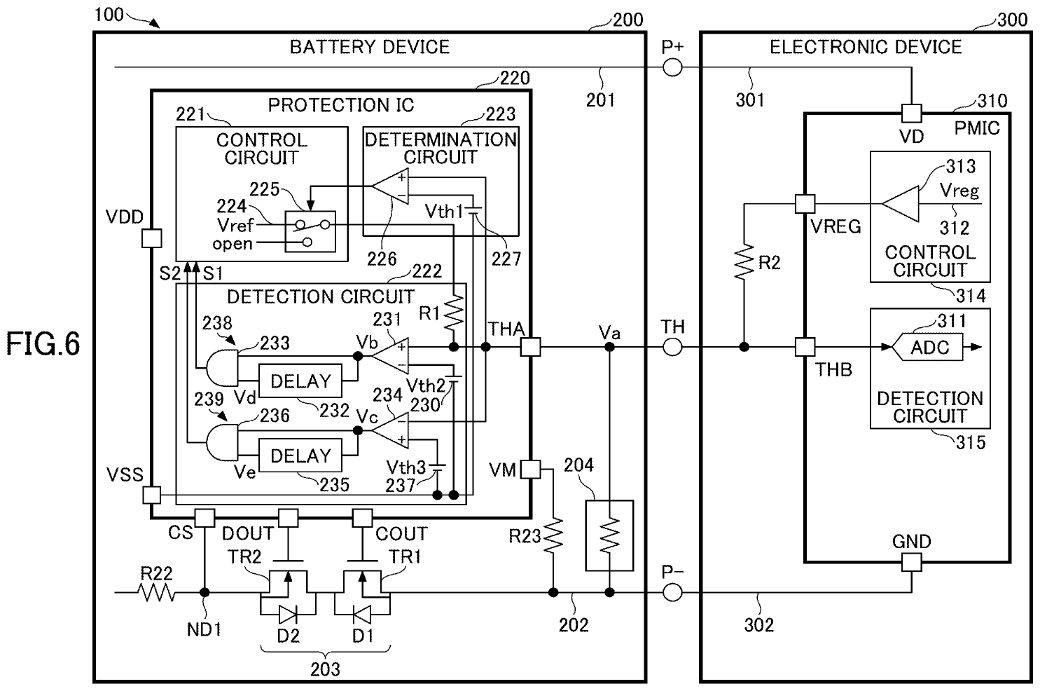

FIG. 6 is a diagram that shows example structures of the determination circuit 223 and the detection circuit 222. The determination circuit 223 illustrated in FIG. 6 determines whether or not the terminal voltage Va is in the first voltage range A1 by comparing the terminal voltage Va with the threshold voltage Vth1. The detection circuit 222 illustrated in FIG. 6 determines whether or not the terminal voltage Va is outside the predetermined range A3 by comparing the terminal voltage Va with the threshold voltage Vth2 and the threshold voltage Vth3.

In FIG. 6, the determination circuit 223 includes a comparator 226 that compares the terminal voltage Va with the constant threshold voltage Vth1 and a threshold voltage source 227 that generates the constant threshold voltage Vth1. The comparator 226 outputs a signal to turn on the switch 225 when the terminal voltage Va is lower than the threshold voltage Vth1 and outputs a signal to turn off the switch 225 when the terminal voltage Va is higher than the threshold voltage Vth1. The threshold voltage source 227 generates a constant threshold voltage Vth1 (for example, 0.6 volts) by dividing, for example, a band gap reference voltage (approximately 1.25 volts).

In FIG. 6, the detection circuit 222 includes a temperature detection circuit 238 and a temperature detection circuit 239. The temperature detection circuit 238 is a circuit that detects an abnormally low temperature, which corresponds to the terminal voltage Va higher than the threshold voltage Vth2, by using the resistance element R1 that pulls up the terminal THA to the reference voltage source 224. The temperature detection circuit 239 is a circuit that detects an abnormally high temperature, which corresponds to the terminal voltage Va lower than the threshold voltage Vth3, by using the resistance element R1 that pulls up the terminal THA to the reference voltage source 224.

The temperature detection circuit 238 includes a threshold voltage source 230, a comparator 231, a delay circuit 232, and an AND circuit 233. The threshold voltage source 230 generates a constant threshold voltage Vth2 (for example, 0.4 volts), which corresponds to the minimum threshold temperature tha1, for example, by dividing a band gap reference voltage (approximately 1.25 volts). The comparator 231 compares the terminal voltage Va with the constant threshold voltage Vth2. The comparator 231 outputs a low-level signal Vb when the terminal voltage Va is lower than the threshold voltage Vth2 and outputs a high-level signal Vb when the terminal voltage Va is higher than the threshold voltage Vth2. The delay circuit 232 outputs a signal Vd, which is obtained by delaying the signal Vb by the temperature detection delay time described above. The AND circuit 233 outputs a signal S1, which is the logical conjunction of the signal Vb and the signal Vd. The signal S1 is an example of a predetermined signal S described above.

The temperature detection circuit 239 includes a threshold voltage source 237, a comparator 234, a delay circuit 235, and an AND circuit 236. The threshold voltage source 237 generates a constant threshold voltage Vth3 (for example, 0.1 volts), which corresponds to the maximum threshold temperature tha2, for example, by dividing a band gap reference voltage (approximately 1.25 volts). The comparator 234 compares the terminal voltage Va with a constant threshold voltage Vth3. The comparator 234 outputs a high-level signal Vc when the terminal voltage Va is lower than the threshold voltage Vth3 and outputs a low-level signal Vc when the terminal voltage Va is higher than the threshold voltage Vth3. The delay circuit 235 outputs a signal Ve, which is obtained by delaying the signal Vc by the temperature detection delay time described above. The AND circuit 236 outputs a signal S2, which is the logical conjunction of the signal Vc and the signal Ve. The signal S2 is an example of a predetermined signal S described above.

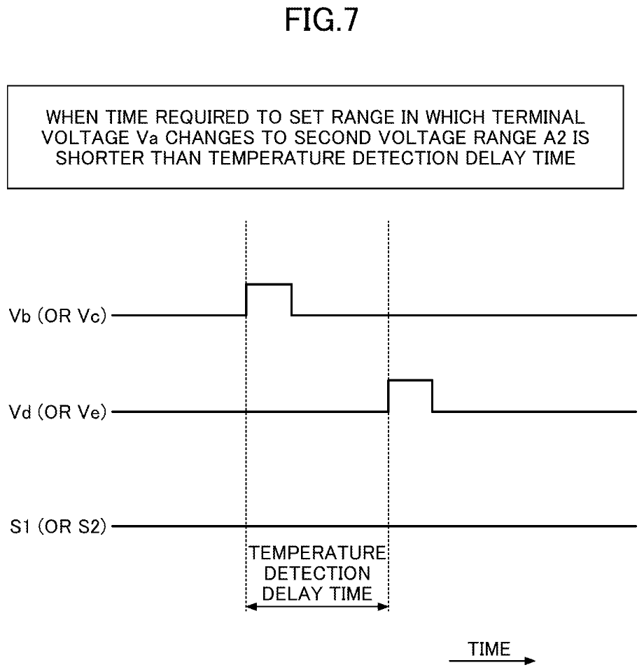

FIG. 7 is a timing chart that shows examples of operating waveforms of the temperature detection circuit 238 and the temperature detection circuit 239 (when the electronic device 300 stops controlling the terminal voltage Va to vary within the second voltage range A2, in a period of time that is shorter than the temperature detection delay time). In this case, the time in which the signal Vb output from the comparator 231 (or the signal Vc output from the comparator 234) is at the high level is shorter than the temperature detection delay time, and so the signal S1 (or signal S2) is not asserted. In this way, if controlling the terminal voltage Va to vary within the second voltage range A2, is stopped in a period of time that is shorter than the temperature detection delay time, the temperature detection circuit 238 (or the temperature detection circuit 239) does not erroneously assert the signal S1 or the signal S2.

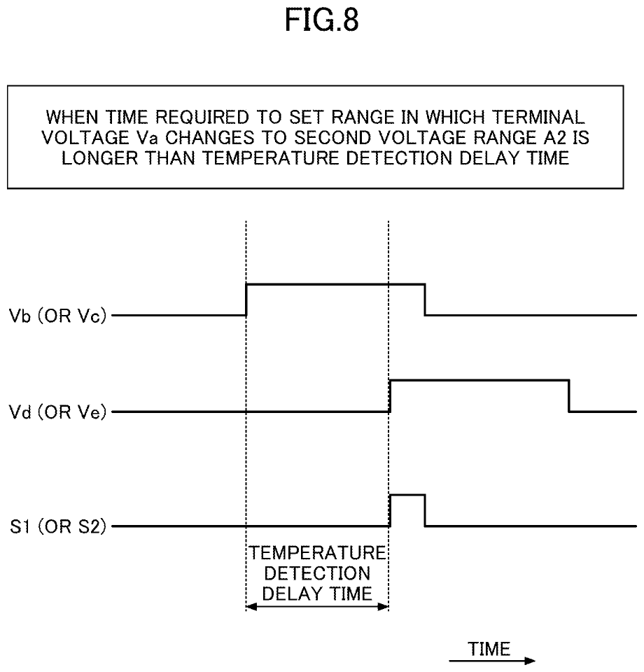

FIG. 8 is a timing chart that shows examples of operating waveforms of the temperature detection circuit 238 and the temperature detection circuit 239 (when the electronic device 300 stops controlling the terminal voltage Va to vary within the second voltage range A2, in a period of time longer than the temperature detection delay time). In this case, the time during which the signal Vb output from the comparator 231 (or the signal Vc output from comparator 234) is at the high level is longer than the temperature detection delay time, and so the signal S1 (or the signal S2) is asserted. As described above, if controlling the terminal voltage Va to vary within the second voltage range A2 takes longer than the temperature detection delay time, the temperature detection circuit 238 (or the temperature detection circuit 239) asserts the signal S1 or the signal S2. By this means, the detection circuit 222 can notify the control circuit 221 when there is some problem.

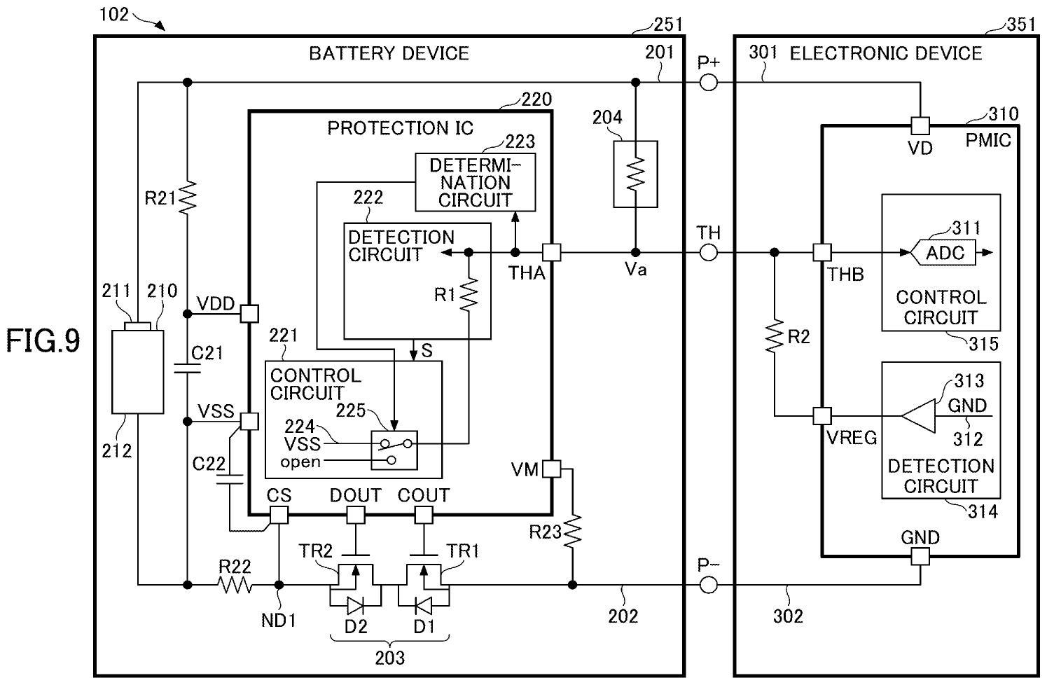

FIG. 9 is a circuit block diagram that shows an example of a system including a secondary battery protection integrated circuit according to a second embodiment. In the second embodiment, components, functions, and effects that are the same as in the first embodiment described above will not be described or will be described only briefly, and reference should be made to the above first embodiment in such parts. The second embodiment differs from the first embodiment in that the temperature detecting element 204 is connected between the power supply line 201 and the terminal THA.

The system 102 according to the second embodiment includes a battery device 251 and an electronic device 351.

The system 102 is an example of a temperature sensor sharing system. In this example, the battery device 251 and the electronic device 351 use the temperature detecting element 204 on a shared basis.

If the determination circuit 223 determines that the terminal voltage Va is in the first voltage range A1, the control circuit 221 pulls down the terminal THA to the reference voltage source 224, via the resistance element R1, by turning on the switch 225. On the other hand, if the determination circuit 223 determines that the terminal voltage Va is not in the first voltage range A1, the control circuit 221 stops pulling down the terminal THA to the reference voltage source 224 via the resistance element R1, by turning off the switch 225. According to the second embodiment, the reference voltage source 224 has the same potential as the terminal VSS.

The detection circuit 222 in the battery device 251 includes a resistance element R1. The detection circuit 222 detects the terminal voltage Va at the terminal THA by using the resistance element R1 that pulls down the terminal THA to the reference voltage source 224. On the other hand, the detection circuit 315 in the electronic device 351 detects the terminal voltage Va, which is input via the terminal TH and the terminal THB, by using the resistance element R2 that pulls down the terminal TH and the terminal THB to the reference voltage source 312. In the second embodiment, the reference voltage source 312 has the same potential as the terminal GND.

In the second embodiment shown in FIG. 9, when monitoring the temperature of the battery device 251, the control circuit 314 in the electronic device 351 activates the connection between the terminal THA and the reference voltage source 312 by means of the buffer 313. In this example, the control circuit 314 sets the level of the terminal VREG to an active level (the low level in this example) by turning on the buffer 313. Turning on the buffer 313 enables the resistance element R2. In this way, by turning on the buffer 313, the control circuit 314 controls the terminal voltage Va to vary in accordance with changes of the resistance value of the temperature detecting element 204, within the second voltage range A2, which is different from the first voltage range A1.

When the terminal voltage Va is controlled to vary in accordance with changes of the resistance value of the temperature detecting element 204, within the second voltage range A2, the terminal voltage Va shifts to the second voltage range A2, so that the determination circuit 223 in the battery device 251 determines that the terminal voltage Va is not in the first voltage range A1. If the determination circuit 223 determines that the terminal voltage Va is not in the first voltage range A1, the control circuit 221 in the battery device 251 turns off the switch 225. By turning off the switch 225, the control circuit 221 stops connecting the terminal THA to the reference voltage source 224 via the resistance element R1. By turning off the switch 225, the resistance element R1 is disabled. Thus, the control circuit 221 deactivates the connection between the terminal THA and the reference voltage source 224 by means of the switch 225, thereby stopping controlling the terminal voltage Va to vary in accordance with changes of the voltage value of the temperature detecting element 204, within the first voltage range A1. Therefore, the detection circuit 315 is unaffected by the resistance value of the resistance element R1, and still can detect the voltage that is obtained by dividing the power-supply voltage between the terminal VD and the terminal GND between the resistance element R2 and the temperature detecting element 204, as the terminal voltage Va.

Next, when the control circuit 314 in the electronic device 351 stops monitoring the temperature of the battery device 251, the control circuit 314 deactivates the connection between the terminal THA and the reference voltage source 312 by means of the buffer 313. In this example, the control circuit 314 sets the terminal VREG to a high impedance by turning off the buffer 313. By setting the terminal VREG to a high impedance, the resistance element R2 is disabled, so that the terminal voltage Va shifts from the second voltage range A2 to the first voltage range A1. In this way, by turning off the buffer 313, the control circuit 314 stops controlling the terminal voltage Va to vary, in accordance with changes of the resistance value of the temperature detecting element 204, within the second voltage range A2.

When the terminal voltage Va shifts to the first voltage range A1, the determination circuit 223 in the battery device 251 determines that the terminal voltage Va is in the first voltage range A1. When the determination circuit 223 determines that the terminal voltage Va is in the first voltage range A1, the control circuit 221 in the battery device 251 turns on the switch 225. By turning on the switch 225, the control circuit 221 pulls down the terminal THA to the reference voltage source 224 via the resistance element R1. By turning on the switch 225, the resistance element R1 is enabled. Thus, by activating the connection between the terminal THA and the reference voltage source 224 by means of the switch 225, the control circuit 221 controls the terminal voltage Va to vary in accordance with changes of the resistance value of the temperature detecting element 204, within the first voltage range A1.

Therefore, the detection circuit 222 is unaffected by the resistance value of the resistance element R2, and can still detect the voltage that is obtained by dividing the power-supply voltage between the power supply line 201 and the terminal VSS between the resistance element R1 and the temperature detecting element 204, as the terminal voltage Va.

In this way, according to the second embodiment shown in FIG. 9, the electronic device 351 (PMIC 310) and the battery device 251 (protection IC 220) can use the temperature detecting element 204, for temperature detection, on a shared basis.

Note that the resistance element R1 and the resistance element R2 according to the first embodiment and the second embodiment may be replaced with constant current sources. The temperature detecting element 204 whose resistance value varies in accordance with changes in temperature may be replaced with a temperature detecting element 204 whose voltage value varies in accordance with changes in temperature.

Now, although embodiments of the present disclosure have been described above, these embodiment have been presented only as examples, and the present invention is by no means limited to the embodiments described herein. The above embodiments can be implemented in a variety of other forms, and various combinations, omissions, substitutions, changes, and so forth can be made without departing from the gist of the invention. These embodiments and their modifications are included within the scope and gist of the invention, as well as within the scope of the invention recited in the claims attached herewith and its equivalents.

For example, the positions to arrange the charge control transistor TR1 and the discharge control transistor TR2 may be swapped with each other with respect to the illustrated positions.

Also, the techniques described in the present disclosure are by no means limited to the case in which the charge control transistor TR1 and the discharge control transistor TR2 are inserted in the grounding wire 202, and can also be applied to, for example, cases in which the charge control transistor TR1 and the discharge control transistor TR2 are inserted in the power supply line 201.

Also, in the embodiments described herein, the battery device (protection IC) has a first temperature detection function to: determine whether the terminal voltage Va at a terminal that is connected with a temperature sensor, in which a physical quantity, which is the resistance value or the voltage value, varies due to changes in temperature, is in the first voltage range A1; when it is determined that the terminal voltage Va is in the first voltage range A1, control the terminal voltage Va to vary in accordance with changes of the physical quantity, within the first voltage range A1; and, when it is determined that the terminal voltage Va is not in the first voltage range A1, stop controlling the terminal voltage Va to vary in accordance with changes of the physical quantity, within the first voltage range A1, and detect temperature based on the terminal voltage Va. The electronic device has a second temperature detection function to control the terminal voltage Va to vary in accordance with changes of the physical quantity, within a second voltage range A2, which is different from the first voltage range A1, and detect the temperature based on the terminal voltage Va. However, it is equally possible to impart the second temperature detection function to the battery device (protection IC) and the first temperature detection function to the electronic device.

Also, the second voltage range A2 is not limited to a range in which the voltage value is higher than in the first voltage range A1, and may be a range in which the voltage value is lower than in the first voltage range A1.

The buffer 313 may be replaced with a switch. The switch 225 may be replaced with a buffer.

What is claimed is:

1. A temperature sensor sharing system comprising:
a temperature sensor, in which a physical quantity varies due to changes in temperature, the physical quantity being a resistance value or a voltage value;
a terminal to which the temperature sensor is connected;
a first device; and
a second device,
wherein the first device includes:
a determination circuit configured to determine whether or not a terminal voltage at the terminal is in a first voltage range;
a first control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
a first detection circuit configured to detect the terminal voltage, and
wherein the second device includes:
a second control circuit configured to control the terminal voltage to vary in accordance with changes of the physical quantity, within a second voltage range, which is different from the first voltage range; and
a second detection circuit configured to detect the terminal voltage.

2. The temperature sensor sharing system according to claim 1, wherein the second control circuit stops controlling the terminal voltage to vary in accordance with changes of the physical quantity, within the second voltage range, within a period of time that is shorter than a predetermined first period of time.

3. The temperature sensor sharing system according to claim 2, wherein, when the first detection circuit continues detecting the terminal voltage outside the first voltage range or outside a predetermined range included within the first voltage range, for the predetermined first period of time, the first detection circuit asserts a predetermined signal that indicates that the voltage terminal has moved out of the predetermined voltage range.

4. The temperature sensor sharing system according to claim 3,
wherein the first device further includes:
a secondary battery; and
a transistor provided on a current path that is connected to the secondary battery,
wherein, when the predetermined signal is asserted, the first control circuit controls the transistor to disconnect the current path.

5. The temperature sensor sharing system according to claim 3,
wherein the determination circuit determines whether or not the terminal voltage is in the first voltage range by comparing the terminal voltage with a first threshold voltage, and
wherein the first detection circuit determines whether or not the terminal voltage is outside the predetermined range by comparing the terminal voltage with a second threshold voltage that is included in the first voltage range.

6. The temperature sensor sharing system according to claim 1,
wherein the first device further includes a first reference voltage source, and
wherein the first control circuit controls the terminal voltage to vary in accordance with changes of the physical quantity, within the first voltage range, by activating a connection between the terminal and the first reference voltage source, and stops controlling the terminal voltage to vary within the first voltage range, by deactivating the connection between the terminal and the first reference voltage source.

7. The temperature sensor sharing system according to claim 1,
wherein the second device further includes a second reference voltage source, and
wherein the second control circuit controls the terminal voltage to vary in accordance with changes of the physical quantity, within the second voltage range, by activating the connection between the terminal and the second reference voltage source, and stops controlling the terminal voltage to vary within the second voltage range, by deactivating the connection between the terminal and the second reference voltage source.

8. The temperature sensor sharing system according to claim 1,
wherein the first device further includes a first reference voltage source,
wherein the first control circuit controls the terminal voltage to vary in accordance with changes of the resistance value, within the first voltage range, by setting an electrical resistance between the terminal and the first reference voltage source to a first resistance value,
wherein the second device further includes a second reference voltage source, and
wherein the second control circuit controls the terminal voltage to vary in accordance with changes of the resistance value, within the second voltage range, by setting the electrical resistance between the terminal and the second reference voltage source to a second resistance value.

9. The temperature sensor sharing system according to claim 1,
wherein the first device includes a first reference voltage source,
wherein the first control circuit controls the terminal voltage to vary in accordance with changes of the voltage value, within the first voltage range, by setting a current that flows between the terminal and the first reference voltage source to a first constant current value,
wherein the second device includes a second reference voltage source, and
wherein the second control circuit controls the terminal voltage to vary in accordance with changes of the voltage value, within the second voltage range, by setting the current that flows between the terminal and the second reference voltage source to a second constant current value.

10. A secondary battery protection integrated circuit configured to protect a secondary battery by controlling a transistor provided on a current path that is connected to the secondary battery, the secondary battery protection integrated circuit comprising:
a terminal that is connected with a temperature sensor, in which a physical quantity varies due to changes in temperature, the physical quantity being a resistance value or a voltage value;
a determination circuit configured to determine whether or not a terminal voltage at the terminal is in a first voltage range;
a control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
a detection circuit configured to detect the terminal voltage.

11. The secondary battery protection integrated circuit according to claim 10, wherein, when the detection circuit continues detecting the terminal voltage outside the first voltage range or outside a predetermined range included within the first voltage range, for a first period of time, the control circuit controls the transistor to disconnect the current path.

12. The secondary battery protection integrated circuit according to claim 11, wherein, when the detection circuit continues detecting the terminal voltage outside the first voltage range or outside the predetermined range included within the first voltage range, for the first period of time, the control circuit controls the transistor to disconnect the current path regardless of whether or not a problem related to charging or discharging is detected with respect to the secondary battery.

13. A battery device comprising:
a secondary battery;
a transistor provided on a current path that is connected to the secondary battery;
a temperature sensor, in which a physical quantity varies due to changes in temperature, the physical quantity being a resistance value or a voltage value;
a terminal, to which the temperature sensor is connected;
a determination circuit configured to determine whether or not a terminal voltage at the terminal is in a first voltage range;
a control circuit configured to control the terminal voltage to vary in accordance with changes of the physical quantity, within the first voltage range, when the determination circuit determines that the terminal voltage is in the first voltage range, and stop controlling the terminal voltage to vary within the first voltage range when the determination circuit determines that the terminal voltage is not in the first voltage range; and
a detection circuit configured to detect the terminal voltage.

14. A method of detecting temperature, involving a first device and a second device, the method comprising:
in the first device:
determining whether or not a terminal voltage at a terminal, to which a temperature sensor, in which a physical quantity varies due to changes in temperature, is connected, is in a first voltage range, the physical quantity being a resistance value or a voltage value;
controlling the terminal voltage to vary in accordance with changes of the physical quantity, within the first voltage range, when the terminal voltage is determined to be in the first voltage range, and stopping controlling the terminal voltage to vary within the first voltage range when the terminal voltage is determined not to be in the first voltage range; and
detecting temperature based on the terminal voltage, and
in the second device:
controlling the terminal voltage to vary in accordance with changes of the physical quantity, within a second voltage range, which is different from the first voltage range; and
detecting temperature based on the terminal voltage.
